(19) United States
(12) Patent Application Publication
(10) Pub. No.: US 2007/0146484 A1
(43) Pub. Date: Jun. 28, 2007

(54) AUTOMATED VIDEO SYSTEM FOR CONTEXT-APPROPRIATE OBJECT TRACKING

(76) Inventors: Joshua Horton, Morrisville, PA (US); Jason Beck, Allentown, NJ (US)

Correspondence Address: DUANE MORRIS LLP, PO BOX 5203, PRINCETON, NJ, 08543-5203, US

(21) Appl. No.: 11/560,686

(22) Filed: Nov. 16, 2006

Related U.S. Application Data
(60) Provisional application No. 60/737,216, filed on Nov. 16, 2005.

(51) Int. Cl. H04N 7/18; H04N 5/225

(52) U.S. Cl. 348/159; 348/169

(57) ABSTRACT

A system and methods for generating an optimized video stream of a target that is moving within a predefined area uses an automated video system provided with a plurality of video cameras that are positioned about the predefined area by tracking the moving target and determining which of the video cameras is positioned to provide the user defined optimal view of the target and integrating the video stream from that camera to the optimized video stream.

### CROSS REFERENCE TO RELATED APPLICATIONS

This application claims the benefit of U.S. Provisional Application Ser. No. 60/737,216, filed on Nov. 16, 2005, the entire disclosure of which is incorporated herein by reference.

### FIELD OF THE INVENTION

This invention relates to an automated video system for use in sporting events or training sessions to generate a video recording of the event that is optimized for the particular event or session and allow viewing of the video recording concurrently or at a later time.

### BACKGROUND

An athlete's form, body position and execution are important ingredients in all sports and thus video recording of an athlete's performance is a commonly utilized tool for the athlete's training regimen. Some sports, like equestrian sports, have added complexities which include the rider's or trainer's responsibility for the horse's physical development and training, as well as their responsibility for creating a synergistic relationship between the horse and the rider. Communication between the horse and the rider is based upon a language of tactile cues, executed thru touch and adjustments of balance. Because of the intricacies of equestrian sport, it is important for the participants, whether they are professional horse trainers, novice students or Olympians, to receive assistance or instructions from another person as often as possible. The key elements of equestrian sport are the rider's body posture, the correct positioning of a rider's body when applying tactile cues to the horse, confirming that the horse has responded correctly to the rider's cues and the horse's way of carrying itself. Because visual observations are so important to the training of horses and riders, video recordings are particularly useful tools for the rider and her instructor and the horse and its trainer.

The use of recorded video images for the purpose of evaluating the performance of a horse and/or a rider is commonplace in equestrian sport. The most common method of attaining these video images is through the use of a single video camera. The camera is usually operated by an assistant who tracks the subject, rider and the horse, keeping them in the camera's field of view and zooming in or out to keep the subject at a consistent size in the camera frame. Alternatively, the camera is mounted on a tripod and simply set to record.

In the first situation it is necessary for a mounted horse trainer or a mounted student rider to have an assistant available to operate the video camera. It is often too expensive or inconvenient for an assistant to be present for what could be as many as 10 hours a day to record horses and riders. Additionally, the quality of the video is dependent on the skill of the operator and the quality of the video can be inconsistent.

In the second situation, the video camera is set on a tripod with the camera set to record and no assistant is needed. Although most video cameras have auto-focus capabilities, the student or trainer is forced to be satisfied with the camera lens set to a fixed zoom. Thus, images obtained with this method will always be a compromise. When the lens is preset at a wide angle zoom setting covering the entire riding space the subject (rider and the horse) will appear too small on the viewing screen and will not be recognizable. When the camera is preset to a zoomed in (i.e. close-up view) the subject will pass in and out of the field of view. Mounting the camera on a motorized panning stand that follows a transmitter placed on the rider will alleviate that problem but still have the problem of being limited to a single view point.

Other shortcomings with these conventional methods of video recording include the fact that a single camera will not provide video of a training exercise from multiple viewing positions as is desirable during many mounted exercises. Often viewing the horse and the rider from the front and the side will provide the instructor or the trainer with important information about the correctness of the exercise being performed.

Additionally, current commercially available recording and display equipment requires the user to manually stop recording and manually start and stop the rewind process in order to find the desired section of the video segment for viewing. It is also necessary to manually find the end of the recorded video recording to begin new recording. These processes can generally take up to 30 to 120 seconds to complete, not including viewing time.

There are further complications and inconveniences involving operating the video camera or the associated video recording devices. These devices either require someone other than the mounted rider to operate them or to use a remote control unit that is not particularly suited for use while on a horse and wearing riding gloves. These situations significantly interrupt the flow of a training session, create a significant a loss of time during a student's lesson and potentially create a safety hazard while the rider is trying to operate a remote control unit not designed for use while mounted.

Prior art systems have used video cameras and computers to enhance sports training in general, but the unique demands of equestrian training require specific features in order for the successful adoption of such technologies. In contrast with the sport of golf, for example, which is played on large fields but which athletic portion consists of a fairly compact motion of swinging a club, equestrian sporting maneuvers require fairly sizable area in which to execute the athletic maneuvers. This can be directly attributed to the size of the animal and the precision with which such maneuvers must be carried out, often requiring several strides for set-up before execution of a maneuver. For this reason, simply setting a camera on a tripod, or installing one or more cameras, in the arena, and recording the session too often yields a video sequence that is out-of-focus, out-of-view or obstructed for large parts of the session. The exactness of the cue given to the horse requires very precise hand, leg and body movements, so video which captures a horse but cannot reveal these movements in any kind of detail is just not worth capturing.

Because of the simplicity of the prior art video recording systems used in equestrian sport, the unique physical movements specific to equestrian training have not been properly addressed. Prior art systems which have been designed to track horses in racing scenarios do not accommodate selective tracking and recording for training purposes. For example, different sequence of views will be optimal for reviewing a particular style of riding, such as dressage, compared to another style of riding, such as stadium jumping. This is because the different disciplines require different postures of both the horse and rider, and some postures are better viewed from one angle than other. Even in other sports activities, a video recording of an athlete's performance that can provide various optimal views of the athlete during a performance session, whether it be a practice session or in competition, would be useful. Further, the prior art systems which provide for tracking of athletes engaged in other sporting events do not provide for a simple way to review one's practice session in the middle of the session.

Thus, there is a need for an easy-to-use, automated video system that will track and follow an athlete through a performance session and generate a video stream of a sequence of optimal views.

### SUMMARY

In an embodiment, a system and method for generating an optimized video stream of a target that is moving within a predefined area using an automated video system provided with a plurality of video cameras, each producing a video stream, that are positioned about the predefined area is disclosed. The method comprises defining the predefined area into a plurality of zones and then defining a desired optimal view for each of the zones through which the target will be traveling through during a performance routine. An optimal view can be defined in terms of a front-view, side-view, rear-view, front-right-view, etc., depending on the requirements of a particular characteristics of the target and its movement being tracked and recorded. In other words, for different sporting events, what are considered as optimal views will be different but the automated video system is configured to accommodate such different definitions of “optimal views.” For example, in equestrian sports, front-view and side-view are the commonly desired options for an “optimal view.” Next, the system determines the location and orientation of the target as the target is performing the performance routine and then identifying the zone in which the target is at that moment as the active zone. Next, the system determines which of the plurality of video camera has the predefined optimal view of the target for that active zone, i.e. the optimal video camera. Then, the system designates the video stream coming from the optimal video camera as the optimized video stream.

In another embodiment, the method for generating an optimized video stream comprises defining a desired optimal view for generating the optimized video stream for a performance routine to be performed by the target. Next, the system determines the location and orientation of the target as the target is moving through the performance routine and using the information on the location and orientation of the target, the system determines a video camera that has the predefined optimal view of the target among the plurality of video cameras available to the system. The system, then, designates the video stream coming from the video camera having the optimal view as the optimized video stream.

In yet another embodiment, the method for generating an optimized video stream comprises defining the predefined area into a plurality of zones and then assigning a video camera from the plurality of video cameras to each of the plurality of zones to provide an optimal view of the target. Next, the system determines the position of the target moving trough the predefined area and identifying the zone in which the target is as an active zone. Once it is determined which zone is the active zone, system designates the video stream from the video camera assigned to the active zone as the optimized video stream.

The invention also includes the automated video system for generating the optimized video stream. The system comprises a Target Sensing subsystem for acquiring the location and orientation of the target and generate target location and orientation data. A plurality of video cameras are provided positioned about the predefined area in which the target will be moving about. A Camera Control subsystem controls the video cameras to track the target utilizing the target location data. A User Interface subsystem, such as a graphic-user-interface, is provided in the system through which a user defines at least one optimal view of the target to be used for generating the optimized video stream. A Central Command Component of the system determines and selects a video camera among the plurality of video cameras that has the optimal view of the target and designates the video stream from the selected video camera as the optimized video stream. The system also includes at least one Data Storage subsystem for recording the optimized video stream on a storage medium for future play-back. At least one Display subsystem is provided for visually displaying the optimized video stream.

In all embodiments disclosed herein, the system can do whatever is appropriate and desired with the optimized video stream. For example, the system can send the optimized video stream live to a display panel provided in the predefined area. The display panel is preferably sufficiently large and located at a location that is easily visible to the target in the predefined area and others that also may be in the predefined area or nearby. The system can also display or play-back the optimized video stream to the display panel in a time-delay mode so that the target, such as an equestrian rider in a practice session can view the optimized video of herself with a time lag, either throughout the practice session or upon completion of a session. The optimized video stream can be recorded on to a long-term storage media such as a video tape, DVD, computer hard-drive, removable memory cards and the like. The optimized video stream can also be transmitted electronically to a remote destination via a communications network such as the Internet. This feature allows the optimized video stream to be sent, for example, to a remotely located trainer or a coach for viewing.

In another embodiment, the system records not only the optimized video stream but the video streams from all of the video cameras available to the system. This enables the optimized video stream to be subsequently revised and edited using video clips from the stored video streams.

The system and method of the present invention is applicable to various activities such as sports or other non-sports performances. Thus, the term “target” refers to an athlete or a performer that is the subject to be video recorded by the automated video system while that target is executing a performance. In a ballet performance, the target would be a ballerina. In a sporting activity, the target would be an athlete. In certain type of activity, the target may include more than just the athlete person. In equestrian sports, for example, the target would include both the human rider as well as the horse. The term “predefined area” then refers to an area to within which the target's performance is confined. For example, in an equestrian sports, the predefined area would be the riding arena. In a ballet performance, the predefined area would be the stage or a practice studio. The term “performance routine” refers to the particular piece of an activity that the target is performing or practicing which is to be recorded by the automated video system to generate an optimized video stream.

### BRIEF DESCRIPTION OF THE DRAWINGS

The foregoing and other features and advantages of the invention will be apparent from the following detailed description of various embodiments, as illustrated in the accompanying drawings.

FIG. 1 is a schematic illustration of an embodiment of an automated video system.

FIG. 2 is a schematic illustration of an example of a predefined area provided with a plurality of video cameras according to an embodiment.

FIG. 3 is a schematic illustration of an example of a predefined area provided with a plurality of video cameras illustrating the Reference Cartesian Space Coordinate and Camera Cartesian Space Coordinates.

FIG. 4 is a detailed schematic illustration of the angle of interception between the cameras' line of sight and the target's orientation axis.

FIG. 5 is a schematic illustration of another example of a predefined area provided with a plurality of video cameras according to another embodiment.

FIG. 6 is a schematic illustration of another example of a predefined area provided with a plurality of video cameras according to yet another embodiment.

FIG. 7 is a schematic illustration of a remote control unit configured to be used by a rider on a horse.

### DETAILED DESCRIPTION

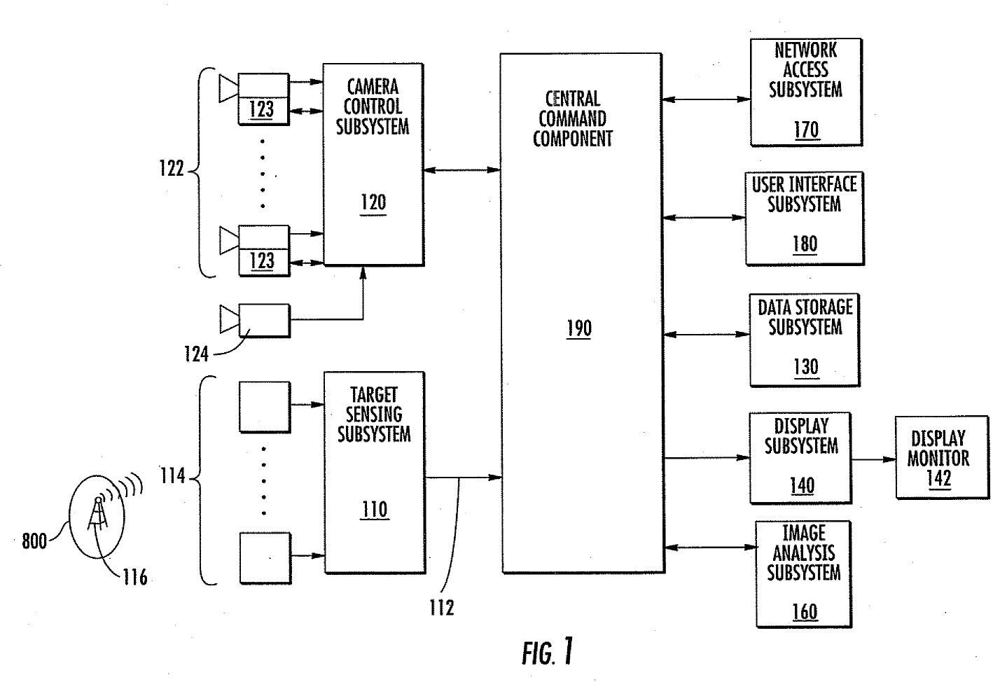

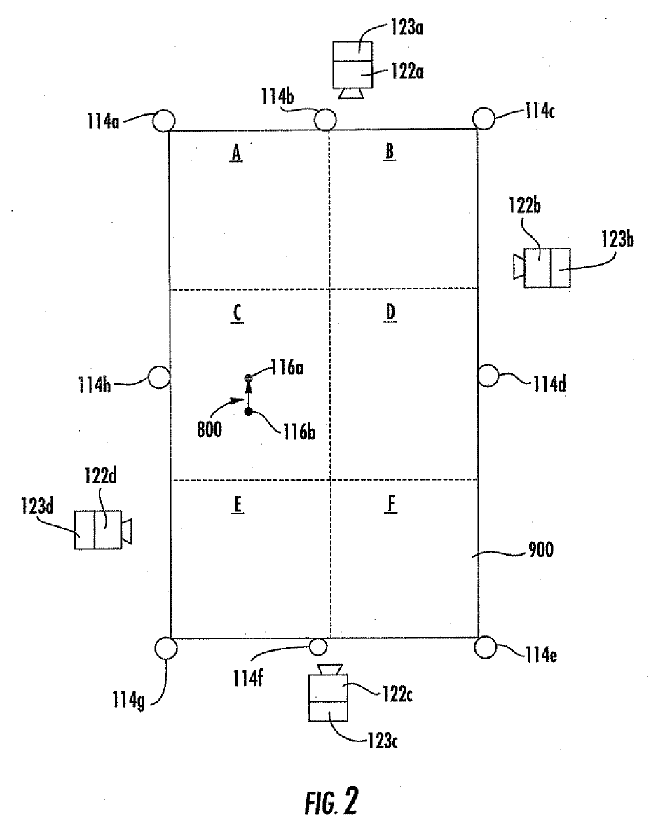

Referring to FIG. 1, an embodiment of an automated video system 100 for generating an optimized video stream of a performance. The system 100 comprises a Target Sensing subsystem 110 for acquiring the location and orientation of the target 800. The Target Sensing subsystem 110 includes a plurality of sensors 114 and one or more transmitter(s) 116 used to determine the location and the orientation, as necessary, of the target 800. The Target Sensing subsystem 110 generates a target data 112 containing information about the target's location and orientation, if appropriate, and provides the data to a Central Command Component 190. A plurality of video cameras 122 are provided positioned about a predefined area 900 (see FIG. 2) in which the target 800 will be moving about. Each of the video cameras are provided with an articulating mechanism 123 that allows the cameras to be articulated to aim at the target 800.

A Camera Control subsystem 120 controls the video cameras 122 to track the target utilizing the target data 112 by sending commands to the articulating mechanisms 123 to aim the video cameras 122 towards the target 800. Using a User Interface subsystem 180, such as a graphical user interface, provided in the system 100, a user can define at least one optimal view of the target to be used for generating the optimized video stream. The Central Command Component 190 of the system determines and selects a video camera among the plurality of video cameras that has the optimal view of the target and designates the video stream from the selected video camera as the optimized video stream. The automated video system 100 also includes at least one Data Storage subsystem 130 for recording the optimized video stream on a storage medium for future play-back. At least one Display subsystem 140 is provided for visually displaying the optimized video stream. The system's Central Command Component 190 controls and coordinates the functions of the various subsystems and processes the various data within the system.

Referring to FIGS. 1 and 2, an example of the automated video system 100 implemented in a horse riding arena, specifically an arena for dressage tests will be discussed. FIG. 2 is a schematic illustration of a predefined area 900 which is a dressage riding arena provided with a plurality of video cameras 122a, 122b, 122c, 122d.

The video cameras 122a, 122b, 122c, 122d may be a fixed type where their viewing angle is fixed but preferably the cameras are an articulating type whose articulating mechanism 123a, 123b, 123c, 123d are motorized and controllable by the Camera Control subsystem 120. More preferably, the articulating mechanisms 123a, 123b, 123c, 123d are pan-tilt-zoom (PTZ) mechanisms that gives each of the video cameras the maximum degrees of freedom of motion for controlling their viewing angles and the ability to zoom in and out for proper framing of the target. The pan and tilt feature also allows the video cameras the ability to track and follow the target as it moves through its performance routine, in this case the rider riding the horse through a set of riding routine in the arena 900. Alternatively, in another embodiment, the video cameras with the PTZ mechanism may be mounted on dollies, booms or other mechanisms to maneuver the video cameras with multiple degrees of freedom, if such installation can be done in a way that is sensitive to the activities being monitored.

Each video camera should be of the highest quality to enable clear, detailed analysis. For example, the video cameras preferably are able to produce 30 to 60 frames per second with 540 TV lines at minimum, and should be color charge couple device (CCD) type to ensure highest quality picture. The video cameras may have auto iris/auto focus/auto zoom capabilities.

The video cameras should be capable of producing output that is compatible with all video format standards, such as with NTSC, SECAM or PAL format, to ensure maximum flexibility in their interoperability with the other components of the system 100. The video cameras are preferably hardened against environmental conditions of temperature, dust, moisture, and light in the current example. The video cameras can be hard-wired to the Camera Control subsystem 120 or can be connected by a wireless connection, depending on the needs of the installation. Data from the camera is sent to the Camera Control subsystem 120.

In this example, the target 800, which is the rider mounted on a horse is graphically represented as an arrow, the head of the arrow representing the horse's head and the tail of the arrow representing the tail of the horse. By way of transmitters provided on the rider and/or the horse, the system recognizes the target and controls the PTZ cameras to track the rider throughout the riding session. In this example, because the orientation of the target 800, in addition to its location, is also important, two transmitters 116a and 116b are provided on the target. The first transmitter 116a representing the head of the horse and the second transmitter 116b representing the tail of the horse. Each transmitter transmits a unique signal which is received by the plurality of sensors 114a-114h and the Target Sensing subsystem 110 determines the location of the target 800 within the arena 900.

The system ensures that the entire athletic event is recorded from the point-of-view of a camera that provides the desired or optimal view, and that each camera's video feed is optimized to include the horse and rider in focus and centered in view for as long as possible. Thus, the system generates an integrated video recording which is an optimized video stream of only those video clips germane or optimal for reviewing the particular style of riding under practice.

For the automated video system 100 to operate the system requires the ability to recognize and determine the target's location and orientation within the arena 900. This can be enabled by a variety of sensor/transmitter technologies that are available. Some examples are: using a plurality of cameras at regular intervals surrounding the arena 900 combined with image recognition algorithms to recognize and locate the subject target; using an overhead global image from an overhead camera 124 positioned over the arena 900 that is superimposed with coordinate values that can be used to mark the subject's position in the arena 900 combined with image recognition and video image-based motion detection algorithms; and triangulation from multiple time-difference-of-arrival/angle-of-arrival sensors.

In one embodiment of the automated video system, a sensor/transmitter technology available from Ubisense Limited, (www.ubisense.net) is utilized to enable that aspect of the automated video system 100. In systems such as Ubisense systems, the location of the transmitter is determined based on time difference of arrival and angle of arrival of the transmitted signal at each of the plurality of the sensors. For optimal signal delivery between the radio transmitter and the sensors, the sensors should be placed sufficiently high. When a signal is received by two or more sensors, the relative location of the transmitter can be ascertained accurately.

Referring to FIG. 2, the transmitters 116a and 116b, are mounted on the target 800, in this case the horse, the transmitter 116a identifying the head of the horse and the transmitter 116b identifying the tail end of the horse. Since the location of each transmitter can be individually resolved by the Target Sensing subsystem 110, the locations of the transmitters 116a and 116b can be used to define the horse's orientation in the arena 900. An array of sensors 114a-114h are positioned around the periphery of the arena 900. As discussed earlier, these sensors are part of the Target Sensing subsystem 110 and the sensors 114a-114h are connected by hardwire or wirelessly to the Target Sensing subsystem 110 to send the sensors' output to the Target Sensing subsystem 110. The Target Sensing subsystem 110 is provided with the necessary software to process the sensors' input into the location of the target 800 in the arena 900. The software is preferably configured to generate the location of the target 800 in a Cartesian coordinate (x,y,z) form but it would be obvious to one of ordinary skill in the art to have the software generate the location of the target 800 in terms of the distance between the target 800 to three of the sensors 114a-114h so that the target's location can be determined by triangulation.

Because the motion of the rider/horse target 800 in the arena 900 is for the most part in 2-dimension along the floor of the arena 900, for the purpose of this exemplary discussion, we will treat the arena 900 space as a 2-dimensional space and the location of the target 800 will be identified in terms of 2-dimensional coordinates (x,y). But it would be obvious to one of ordinary skill in the art to an application requiring 3-dimensional coordinates (x,y,z) as necessary. To generate the location of the target 800 in a Cartesian coordinate form (x,y), the arena 900 is predefined as a Cartesian space by selecting a fixed point in the arena 900 as the reference origin having the coordinate (0,0). This information and the precise dimensions of the arena 900 is preloaded into the Central Command Component 190 and utilized by the Target Sensing subsystem 110. In this example, the corner of the arena 900 where the sensor 114g is positioned is defined as the origin (0,0). The Cartesian space thus defined by the arena 900 will be referred to herein as the Reference Cartesian space and its origin (Rx=0, Ry=0) as the Reference Origin. If the predefined area 900 has a shape that does not have a corner, some other fixed point can be designated as the Reference Origin.

Using knowledge of the Reference Cartesian space which defines the target sensor environment and the locations of the plurality of video cameras 122a, 122b, 122c, 122d in that Reference Cartesian space, classical rotation and translation transforms can be applied to map the sensors' Reference Cartesian Space coordinates to the Cartesian Space coordinates of each of the video cameras, herein referred to as the Camera Cartesian space coordinates. Once such a priori mapping is completed, the target data 112 from the Target Sensing subsystem 110 containing the location of the target 800 in the Reference Cartesian Space coordinate form can be readily converted to the Camera Cartesian Space coordinates for each of the video cameras 122a, 122b, 122c, 122d. This information is then used by the Camera Control subsystem 120 to aim each of the video cameras to the target 800. The Camera Control subsystem 120 does this by sending appropriate commands or controlling signals to the motorized PTZ mechanisms 123a, 123b, 123c, 123d associated with the video cameras 122a, 122b, 122c, 122d, respectively.

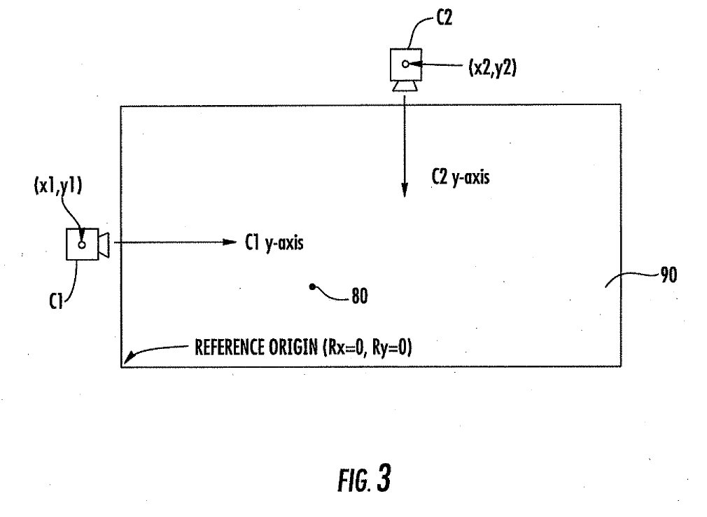

Referring to FIG. 3, an example of the classical rotation and translation transforming the Reference Cartesian Space coordinate to a Camera Cartesian Space coordinate is described. In FIG. 3, a video camera C1 is located at Reference Cartesian Space coordinate (x1, y1) and a second video camera C2 is located at Reference Cartesian Space coordinate (x2, y2) The video cameras define their axes based on their own Cartesian space frame of reference, and so their origin is at a spot relative to their position. As the target 80 moves within the Reference Cartesian space 90, in order for the cameras C1 and C2 to track the movement of the target 80, the position of the target 80 needs to be transformed from Reference Cartesian Space coordinate to the respective Camera Cartesian Space coordinates which will be used to direct the video cameras' PTZ mechanisms to pan and tilt by appropriate amount to aim the cameras to the target 80. This coordinate transformation is as follows:

$$Rotation Transform \text{:}$$

$$( \begin{matrix}x & y & 1\end{matrix} ) * ( \begin{matrix}cos ( α ) & sin ( α ) & 0 \\ - sin ( α ) & cos ( α ) & 0 \\ 0 & 0 & 1\end{matrix} ) = ( x * cos ( α ) - y * sin ( α ) , x * sin ( α ) + y * cos ( α ) )$$

$$Translation Transform \text{:}$$

$$( \begin{matrix}x & y & 1\end{matrix} ) * ( \begin{matrix}1 & 0 & 0 \\ 0 & 1 & 0 \\ dx & dy & 1\end{matrix} ) = ( x + dx , y + dy )$$

$$Scale Transform \text{:}$$

$$( \begin{matrix}x & y & 1\end{matrix} ) * ( \begin{matrix}Sx & 0 & 0 \\ 0 & Sy & 0 \\ 0 & 0 & 1\end{matrix} ) = ( x * Sx , y * Sy )$$

Where, α is the angle of rotation of the video camera with respect to the Reference Cartesian Space. x and y are the Reference Cartesian Space coordinate of the target 80, and df and dy are the Reference Cartesian Space coordinate of the video cameras C1 or C2. The rotation transform about the Reference Cartesian Space coordinate is applied as necessary, followed by a translation transform relative to each of the video cameras C1 and C2. When the video camera is placed along the x-axis wall of the Reference Cartesian Space, the rotation angle is zero. In other words, the video camera and the Reference Cartesian Space share the same angular perspective and no rotational adjustment will be necessary. When the video camera is placed on any other wall a rotation transform is necessary

The subject's position in global coordinates is transformed to commands to move to each camera's relative coordinate position corresponding to the subject's by exploiting the classical rotation and translation transform functions. When combined with a priori knowledge about a camera's fixed position relative to the Reference Origin, these mathematical functions are used to derive the (x,y) coordinates in a video camera's Cartesian Space from any given coordinate in the Reference Cartesian Space.

Preferably, the Reference Cartesian Space coordinates of the target are accessible to programs running on a general purpose microprocessor via an applications programming interface (API). This allows the Reference Cartesian Space coordinate of the target to be provided to the Central Command Component 190 where the rotation and transform functions reside. The rotation and transform functions can be coded in any programming language, such as assembler or “C” and stored in the Central Command Component 190 or hard-coded into the Central Command Component 190 by providing an appropriately programmed ROM chip, for example.

Referring back to FIGS. 1 and 2, a method for generating an optimized video stream of the rider 800 that is riding a horse through a performance routine in an arena 900 according to an embodiment is disclosed. The arena 900 is conceptually defined into a plurality of zones A, B, C, D, E and F and this information a priori stored in the Central Command Component 190 of the automated video system 100. Depending on the particular performance routine, e.g. the riding routine, the rider 800 is to execute, the arena 900 may be divided differently as appropriate. The zone definitions can call for different number and locations for the zones. A number of different zone definitions can be predefined and stored in the automated video system 100.

Next, the user defines a desired optimal view for each of the zones through which the target will be traveling during a performance routine. This information can also be predefined for each of the zone definitions and stored in the system or the user can assign a new set of optimal views to the zones. The user can also edit the optimal view assignments for a predefined zone definitions. In equestrian sports, the optimal views are generally either a front view or a side view of the rider. Thus, in this example, the user would assign either a front view or a side view as the optimal view for each of the regions, A, B, C, D, E and F. Once these definitions are in place, whether it be from a predefined information recalled from the automated video system's memory or input into the system by the user, the rider 800 now begins the performance routine through the arena 900. As the rider 800 is going through the performance routine, the automated video system's Target Sensing subsystem 110 determines the location and orientation of the rider 800 and generates a target data 112 that contains the location and orientation information. From the target data 112, the Central Command Component 190 identifies the zone in which the rider is as an active zone. Next, the Central Command Component 190 determines which of the video cameras 122a, 122b, 122c, 122d has the optimal view of the rider as previously defined for the active zone and designates the video stream from the selected video camera, the optimal camera, as the optimized video stream. Preferably, the video cameras are all always on and tracking the rider 800 and transmitting video feeds, so that as the rider 800 moves through different zones and different camera becomes the optimal camera, the resulting optimized video stream is smooth as possible as the system switches from video feed of one camera to another. Thus, as the rider 800 goes through the performance routine, the video streams from the optimal cameras are captured and integrated into a seamless single optimized video stream of the riding session. The optimized video stream consists of a series of the optimal views of the rider as determined by the rider or the trainer throughout the riding session for the given type of riding involved.

If the automated video system 100 is to be a mobile unit that can be carried from one riding location to another, the system can be preprogrammed with a set of zone definitions and optimal view assignments that are customized for each different riding location and their particular geometry.

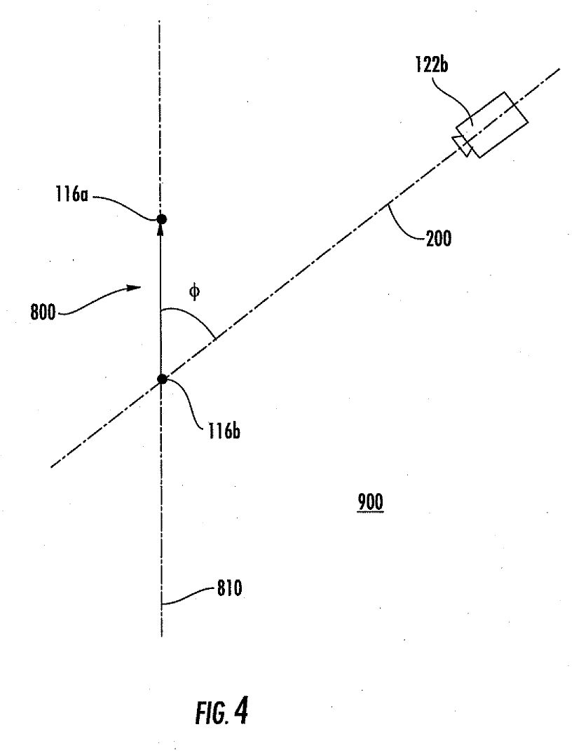

Referring to FIG. 4, the method by which the automated video system 100 determines which of the plurality of video cameras has the optimal view will be described. For each different types of optimal views available, a reference angle of interception associated with the optimal view is defined for the system. The angle of interception refers to the angle between the video camera's line of sight and the target's orientation axis. For example, continuing with the example where the target 800 is a rider on a horse, the target's orientation axis 810 is defined as the straight line connecting the transmitters 116a and 116b representing the orientation of the horse in the arena 900. The line of sight for a video camera is the line representing the direction to which the video camera is aimed. In FIG. 4, the line of sight 200 for the video camera 122b is shown. Because each of the video cameras are tracking and following the target 800, the line of sight for each of the camera will always intersect or intercept the orientation axis 810 of the target 800. For purpose of tracking and following the target 800, the Camera Control subsystem 120 only needs to use the coordinate of one of the two transmitters 116a or 116b and command the video cameras' PTZ mechanisms to aim the cameras at that coordinate. In the example shown in FIG. 4, the camera 122b is aimed at the transmitter 116b and, thus, the line of sight 200 is intercepts the orientation axis 810 at the transmitter 116b. The angle of interception Ø is defined as the angle formed between the line of sight 200 and the orientation axis 810 towards the transmitter 116a. Because the camera's aim is determined by the target's Camera Cartesian Space coordinate, in this case the coordinate of the transmitter 116b, the line of sight 200 for a given camera is the line connecting that camera's origin (0,0) to the point represented by the coordinate of the transmitter 116b in that camera's Camera Cartesian Space coordinate. Thus, the line of sight for each camera at any given moment can be represented by a vector in that camera's Camera Cartesian Space. Similarly, the orientation axis 810 of the target also can be represented by a vector in the camera's Camera Cartesian Space and the Central Command Component 190 then can calculate the angle of interception Ø between the two vectors. The Central Command Component 190 keeps track of this data. As will be described further below, in one embodiment, the system can store the angle of interception data along with the video stream from the cameras for later use.

As discussed above, for equestrian events, optimal views are either front-view or a side-view of the rider 800. The reference angle for a front-view is defined as zero (0) degrees and the reference angle for a side-view is defined as ninety (90) degrees. Thus, to determine which video camera has the optimal view of the target, the system first determines for each of the video cameras, the angle of interception between the video camera's line of sight and the target's orientation axis. Then, the system selects the video camera whose angle of interception Ø is closest to the reference angle of interception associated with the particular optimal view defined.

In generating the optimized video stream, the automated video system 100, however, applies the following rules to further ensure and maximize the usefulness and viewability of the optimized video stream. The first rule for the automated video system 100 is referred to herein as the Distance Rule. This rule requires that the optimal video camera selected to provide the optimized video stream preferably will be farther than a defined minimum distance from the target so that the target is always framed properly. If the target is too close to the optimal video camera, only a portion of the target may be captured. For example, in our equestrian event example, the optimal video camera preferably will be more than about 20 feet from the target rider so that the rider and the horse are always fully captured in the optimized video stream. If the rider is too close to the camera, portions of the horse and/or the rider may be outside the viewing angle of the camera. A second rule for the system is referred to herein as the Time Duration Rule. The Time Duration Rule requires that the video stream from the optimal video camera preferably will be used as the optimized video stream for a minimum duration. Thus, once a video camera is designated as the optimal video camera, that video camera will stay as the optimal video camera for a minimum duration. This rule prevents the system from switching from one camera to another to rapidly resulting in an optimized video stream that is too choppy to be useful or viewable. When the Distance Rule is in effect, in the unlikely event that more than one video camera is determined to have the optimal view (i.e., their angle of interception is the same), the system will always choose the video camera that is furthest from the target as the optima camera and use the video stream from that camera for the optimized video stream.

According to another embodiment, a method for generating an optimized video stream of a target 800 that is moving within a predefined area 900 using an automated video system equipped with a plurality of video cameras 122a, 122b, 122c, 122d positioned about the predefined area 900 comprises defining a single desired optimal view to be applied to the entire performance routine being performed by the target. The Target Sensing subsystem 110 determines the location and orientation of the target and generates a target data 112. Using the target data information, the Camera Control subsystem 120 commands all video cameras to track and follow the target 800. Using the target data information, the Central Command Component 190 determines which of the video camera among the plurality of video cameras 122a, 122b, 122c, 122d has the optimal view of the target at any given moment. The Central Command Component 190 then designates the video stream from the video camera having the optimal view as the optimized video stream. As discussed above, the Central Command Component 190 determines the video camera having the optimal view by comparing the angle of interception between the line of sight of each of the cameras and the orientation axis of the target 800 to the reference angle associated with the particular optimal view.

Still referring FIGS. 1 and 2, a method of generating an optimized video stream of a rider 800 performing a performance routine within the arena 900 according to another embodiment is disclosed. In this embodiment, the arena 900 is again defined into a plurality of zones A, B, C, D, E and F. Then, a video camera from the plurality of video cameras 122a, 122b, 122c, 122d is assigned to each of the zones as the optimal video camera when the rider 800 moves into that particular zone. This assignment allows the user to create custom or arbitrary assignments of zones to cameras, depending on how best to present the images of the rider 800 when positioned in various zones. The Distance Rule is taken into consideration when assigning the video cameras to the defined zones of the arena 900 so that the rider 800 will always be farther than the defined minimum distance from the assigned camera. The automated video system's Target Sensing subsystem 110 determines the location of the rider 800 moving through the various zones of the predefined area and identifies the zone in which the target is as the an active zone. The Target Sensing subsystem 110 also generates a target data 112 containing the coordinate of the rider. The Camera Control subsystem uses the target data to control the video cameras to track and follow the rider 800. Next, the automatic video system's Central Command Component 190 uses the target data to determine in which zone the rider 800 is and designates the video stream from the video camera assigned to the active zone as the optimized video stream.

The optimized video stream generated by the exemplary methods described herein can be displayed on to a video screen 142 by a Display subsystem 140 to be viewed by the rider and others in the arena and/or also recorded on a permanent or short-term storage devices as necessary. The Prefect Practice view video stream also can be transmitted across a local area network, large area network, the Internet, etc. to be used and viewed by others. The Display subsystem 140 comprises at least one video screen 142 for playing back the optimized video stream. The video screen 142 may be, for example, any suitable video display monitor of suitable size. Preferably, the video screen 142 is a large screen that is mounted at a location easily visible from anywhere in the predefined area. The Display subsystem can include display control circuitry to accommodate for any adverse lighting conditions that may exist in the predefined area to adjust the quality of the image being displayed. Such circuitry is commonly found in television sets.

The optimized video stream can also be displayed onto the video screen 142 automatically with a time delay so that as the rider 800 completes a performance routine, the rider can simply watch the recorded performance on the video screen. The amount of time delay can be readily adjusted. Such time-delay display can be enabled by providing the Central Command Component 190 with a video framegrabber interface and software to dampen the speed of the video frame display.

Thus, the advantage of the automated video system 100 over the existing video recording systems includes the ability for a user such as the rider, the trainer, or another participant in an equestrian practice session to observe the rider's performance in full, during the performance as well as immediately upon completion of the performance, merely by glancing at a video monitor and viewing a playback of the session that is being recorded real time by the automated video system. As discussed, the playback can be a real time live playback or optionally, it can be time-delayed to allow the rider to review movements executed in the moments just prior. The time delay duration can be configurable to any desired length. For example, the rider may prefer to view his or her performance at a 20 second delay or 2 minute delay depending on the particular riding routine being practiced and the particular stage in the progression of his or her practice sessions.

The video data presentation function of the Display subsystem 140 may incorporate audio, tactile or other feedback mechanisms to the rider. The Display subsystem 140 is configured and provided with the appropriate and readily available video data processing circuitry to perform any post-processing on the video images that may be necessary to format the data for the various input/output mechanisms that interact with the subsystem. The Display subsystem 140 may also include such output devices as a photo printer to produce hardcopy photos of a video frame.

In addition to presenting the optimized video stream on the display monitor 142 via the Display subsystem 140, the Central Command Component 190 may store the optimized video stream on various storage solutions. This function may be carried out by the Data Storage subsystem 130. The Data Storage subsystem 130 may provide both short-term storage of the video for short-term playback needs as well as long-term storage for archival and retrieval purposes. Such archival can be made on such storage media as DVD, CD-ROM, removable memory chip devices (e.g. thumb drives) and the like.

The automated video system 100 may also include an Image Analysis subsystem 160 provides an optional functionality of performing image analysis on the video image of the target. Image Analysis subsystem 160 can be provided with appropriate software to analyze the target's motion and/or posture to detect any abnormalities in the condition of the target or measure performance parameters of the target. The particular attributes or parameters about the target such analysis tool may measure will vary according to the particular type of activity and the target being monitored by the automated video system. In the equestrian sport example, the Image Analysis subsystem 160 can be configured with appropriate image analysis software to process the video image of the target and analyze the movement of the horse to determine the physical condition of the horse. Such analysis tool can also be used to analyze and assess the performance of the rider in terms of the rider's technique. The angles of the rider's limbs, the angle between the rider's torso and the limbs, etc. can be measured by the Image Analysis subsystem to determine whether the rider's body position and posture is optimal. The system can maintain a library of images or body position data of other riders and compare the target rider's data to the library data. Such image analysis can be performed using commercially-available image analysis tools operating on the permanent recordings of the session generated by the Data Storage subsystem 130 similar to the way golf swing analyses are conducted. The image analysis can be conducted on the optimized video stream or the video streams coming from any one of the plurality of video cameras available to the system. The image analysis can also be conducted in real time during a performance session or subsequently using the recorded video stream(s).

The automated video system 100 also includes a User Interface subsystem 180 may be implemented in hardware and/or software, and enables the user to interface with the Central Command Component 190 of the automated video system 100 for data input as well as for controlling the various features of the system. The User Interface subsystem 180 may also allow the user to configure and adjust various parameters for operation of the system, as well as enabling the initiation and running of discrete video sessions. It may include but is not limited to the following functions: allow for the switching on or off of the main power of the system; the manipulation of the time-delay setting of the playback mode; fast-forward or reverse of the video playback; selection of predefined or configuration of user-defined target acquisition algorithms; changing of audio volume; preparation of video artifacts; short- or long-term storage of practice session records; transmission of practice sessions across a network; use or preparation for use of the practice session in image analysis.

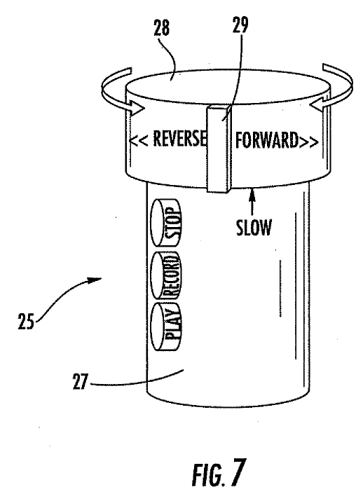

The User Interface subsystem 180 would generally comprise a software portion, similar to the Graphic-User-Interface of a typical personal computer operating system, that manages the user's interaction with the Central Command Component 190 of the system. The User Interface subsystem 180 would generally also include a hardware component in the form of a user interfacing device, such as a keyboard, a panel of buttons, a touch-screen display, or a remote-control device 25 shown in FIG. 7.

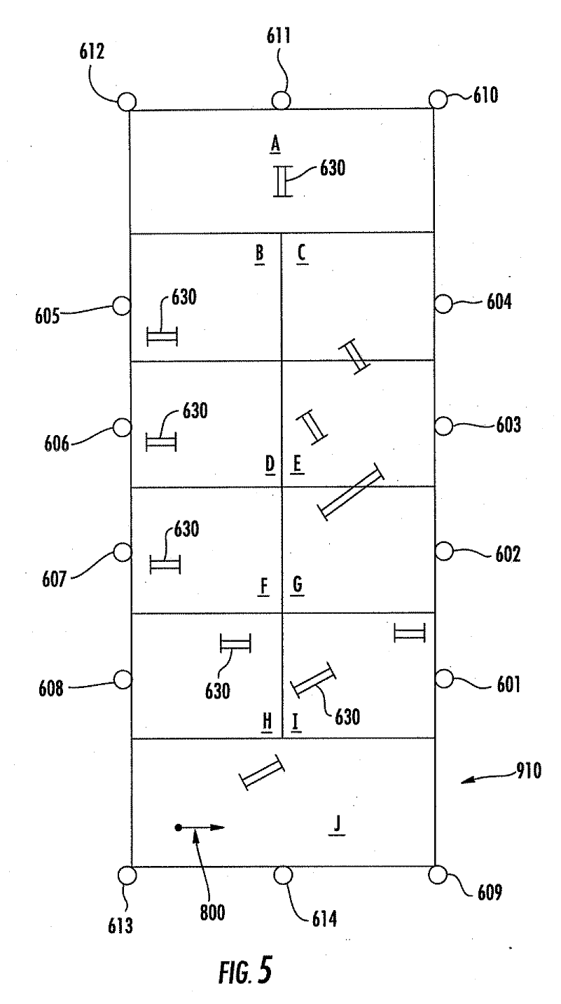

In one embodiment, the automated video system 100 is configured with appropriate software to utilize the target data 112 generated by the Target Sensing subsystem 110 as a user input command for executing various functions of the automated video system 100. Certain locations or zones in the predefined area 900 can be assigned to represent certain command inputs so that when the target 800 stays at the predefined location or a zone for a predefined length of time, it signals the Central Command Component 190 to execute certain commands. For example, in FIG. 5, the zones A and B can be designated to represent “play” and “Stop” commands, respectively, for controlling the play back of the optimized video stream on the display monitor 142. The system can be configured so that when the rider 800 stays in one of the zones A or B for longer than 5 seconds, the Central Command Component 190 will issue the corresponding command to the Display subsystem 140. This feature can be implemented by using the rider's location information provided in the target data 112 which tells the Central Command Component 190 where the rider 800 is and then the Central Command Component 190 can measure how long the rider is staying put in the zone by using its internal clock.

FIG. 7 shows an illustrative embodiment of a remote control device 25. The user (e.g. the rider or the trainer, etc.), for example, can use the remote control device 25 to interface with and control the automated video system 100. The remote control device is configured for portability and useability in horse riding environment. The remote control device 25 can be used to transmit desired control command signals to the Central Command Component 190 to control the various functions provided by the Central Command Component 190 and its various subsystems.

The device 25 is preferably made of a durable lightweight material such as injection-molded plastic or aluminum alloy. The interface device comprises a base 27 that is generally cylindrical in shape and dimensioned for easy for the rider to hold onto. For example, the base 27 can be approximately 8 cm high with a diameter of approximately 2 cm, roughly the size of the handle of a standard dressage riding crop which is a familiar dimension to a rider. This size suggests its intended use: to fit in the palm of a partially-closed hand and allow easy control of the system. It achieves this by using a simple and thoughtful command design that compensates for the diminished attention and manual dexterity of the rider while riding a horse resulting from the rider's use of the reins and from gloved hands, and from the need to focus attention on the details of the motions of the rider and horse.

About 2 cm of the top portion of the base 27 is a thumb cap 28 that is rotatable about the longitudinal axis of the base 27. The thumb cap 28 is rotatable in either clockwise or counterclockwise direction, without allowing any linear motion along the axis of the base. The thumb cap 28 has a ridge 29 that protrudes from the sidewall of the thumb cap 28. The protruding ridge 29 is sufficiently thick, e.g. approximately ⅕ cm, and sufficiently wide, e.g. approximately ¼ cm, to be easily manipulated by the rider using a thumb, knuckle or a finger. In an embodiment, the thumb cap 28 is spring-biased such that when the user grasps the device 25 and applies pressure to the ridge 29 in either direction, the direction of pressure and amount of pressure applied are translated electronically into commands to fast-forward or reverse the Perfect Practice Video Stream at a rate commensurate with the amounts of pressure applied. Upon slackening of the pressure of the thumb against the ridge 29, the spring provides the added benefit of returning the cap to a “home” position, thereby normalizing the video feed to a real-time display of the current activities.

Placed at regular intervals aligned longitudinally along the side of the base are a plurality of buttons for actuating selected functions of system. Each of the buttons can be different color so that they can be readily identified. The buttons are preferably spaced apart at appropriate intervals to allow the rider to align his fingers over the buttons. For example, the buttons can be spaced apart at approximately 1.75 cm intervals to accommodate the fingers of an average person. Each of approximately 1 cm in diameter and approximately ⅛ cm visible height above the diameter of the base. These buttons are activated when the corresponding button is pressed by the fingers of the partially-closed fist of the rider Each button corresponds to one of three specific commands: the bottom button, when pressed, will “Play” from the beginning of the ride currently being recorded or just previously recorded; the middle button, when pressed, will activate the “Record” feature of the system; and the top button, when pressed, will stop recording (if the system is currently recording) or stop playback (if the system is currently in playback mode). In this way the rider need not fumble about with a vast menu of options but can get right to the point by memorizing the simple correspondence between finger placement and function.

The remote control unit 25 features a prominent light-emitting diode (LED—not shown) placed on the top of the thumb cap 28 and indicating whether or not the record function is active. The remote control may be attached around the rider's neck using a lanyard attached to an optional lanyard post (not shown), or it may be placed in a holster in a belt or armband (not shown), with optionally a cord attaching it to the holster to prevent dropping on the ground where it could be smashed by the animal. The remote control unit 25 is powered by standard AA- or C-sized batteries placed inside the body 27 of the unit.

The system 100 may also include a Network Access subsystem 170 providing multiple functions, including: transmission of data to and from other components of the system; transmission of the digital representations of the practice session across the Internet or other public data transmission means to be used by others in real-time. For instance, the optimized video stream can be transmitted over the Internet to a remotely located instructor to provide feedback to the rider. Via the Network Access subsystem 170, video data can be received from a remote sender. This functionality may be provided, for example, using commercially available PC network interface hardware and Fedora Core 5 operating system bundled TCP/IP networking protocol suite software, connected to the Internet over standard Cat. 5 cabling.

The user interface 180 may be used to establish the mappings of the video cameras to the defined zones within the predefined area 900. There also may be pre-defined or default performance routines (e.g. riding algorithms for equestrian sports) pre-loaded in the automated video system 100 specifying the sequences, which are suitable to be used generally for many riding patterns or situations. The video camera assignments may also be influenced by unique features of the practice area, such as restricted views or limitations on camera mounting locations. Although the illustrative embodiment of this function uses algorithms implemented as software running on a microcomputer or similar system, it is understood that similar functionality may be provided using one, two or more algorithms, implemented alone or in combination with other types of control systems, either hardware- or software-based,

The Central Command Component 190 of the automated video system 100 is a central processing unit that manages and coordinates the functions of the various subsystems discussed herein as well as managing the flow of the various data (e.g. the target data 112, various command signals necessary to control the subsystems and other hardware in the system, etc.) within the system as well as performing data processing as necessary. The Central Command Component 190 can be implemented using a general purpose personal computer in which case, the interface software can be configured utilizing the programming tools available for that personal computer's operating system environment. Alternatively, the Central Command Component 190 can be implemented using a special purpose computer customized for this purpose. The various subsystems described herein can be implemented in the automated video system 100 as hardware components separate from the Central Command Component 190 or configured as part of the hardware unit for the Central Command Component 190. In other words, the various subsystems can be provided as specialized interfacing circuits provided as part of the Central Command Component 190. Either way, various hardware solutions are available in the industry for implementing the automated video system 100.

In another embodiment, the automated video system 100 is configured with sufficiently large Data Storage subsystem 130 and the video streams from every video camera in the system are stored in addition to the optimized video stream. The video streams are stored with all the associated data, such as the time and audio data. This will enable the optimized video stream, which is an edited sequence of segments of video streams from different cameras that have been integrated, to be modified later. The user can recall a particular optimized video stream from the Data Storage subsystem 130 and can change the optimal view for any segment of the optimized video stream with a video stream from a different camera. Because the video streams include the associated time data, the system can be configured to recall the recorded video streams from the various cameras that correspond to the particular optimized video stream segment that the user would like to change. The user can browse each video stream and select the desired one for substitution. Furthermore, the system can also store the intercept angle data for each of the video cameras along with the video streams. The intercept angle data would be time synchronized with the video stream for the corresponding camera so that if the user wants to change a portion of the optimized video stream from front view to a side view, for example, the user can have the system select the video stream from a camera that has the optimal side view by checking the intercept angle data. Thus, using the database of recorded video streams, the user can either edit and revise the previously recorded optimized video stream or create new optimized video stream sequences.

An initialization process may be executed when the automated video system 100 is initially installed at a particular predefined area 900 such as a horse riding arena. This initialization process inputs the information on the geometry of the predefined area into the system. In this process, the system is input with a number of parameters, including the dimensions of the predefined area (e.g. length, width, diameter of the area); the number of video cameras and their locations in the predefined area; the areas of space covered by each camera's field of view (this could be variable based on the particular camera's characteristics); and the number of Cartesian coordinate systems, one for each camera, that are rotated and translated about a set of Reference Cartesian Space Coordinates. The transform calculation for each video camera can be executed in the Central Command Component 190 or offloaded to an external processing hardware or software.

As part of the initialization process, the performance routines (e.g. riding routines in the case of an equestrian sport example) may be predefined into the system 100. As noted above, certain performance routines including the information on the zone definition of the predefined area 900 and the associated camera assignments or optimal view definitions for each of the zones can be preloaded or hard-coded into the system prior to installation. The system also provides the user with ability to define other performance routines using a simple scripting language or drag-and-drop function provided with the user interface 180.

The automated video system 100 is flexible so that it can accommodate various types of equestrian events and different riding course layout within the arena. FIG. 5 depicts an example of a more sophisticated horse riding routine, in which the system genereates an optimized video stream of the best views of a rider 800 executing a jumping routine. FIG. 5 is a schematic plan view of the jumping arena 910. A plurality of video cameras 601, 602, 603, 604, 605, 606, 607, 608, 609, 610, 611, 612, 613, and 614 are positioned around various locations around the arena. A number of jumping fences or barriers 630 define the course through which the rider 800 will ride the horse. For the jumping course illustrated n FIG. 5, the arena is conceptually divided into zones, each of which is monitored by a selected camera that is optimally positioned to provide the optimal view of the rider 800 for that zone. For example, in this illustrated embodiment, video cameras 601, 602, 603, 604, 605, 606, 607, 608, 609 and 610 are selected to be used for monitoring and recording the rider 800 going through the jumping course. Each of the cameras are assigned to monitor the following corresponding zones for optimally providing close-up views of the rider as the rider jumps over the barriers 630 in each of the zones:

| Camera | Zone |
|---|---|
| 601 | H |
| 602 | F |
| 603 | D |
| 604 | B |
| 605 | C |
| 606 | E |
| 607 | G |
| 608 | I |
| 609 | J |
| 610 | A |

As the rider rides through the course, the automated video system's Target Sensing subsystem 110, using the sensor/transmitter system described in reference to other embodiments above, determines the location of the rider 800 and generate the target data 112. Using the target data 112, the cameral control subsystem 120 tracks and follows the target with all the video cameras, each video camera transmitting a video stream. Using the target data 112, the Central Command Component 190 determines in which zone the rider 800 is and selects the video stream from the video camera assigned to that zone and integrates that video stream into the optimized video stream. For example, if the rider is in zone C, the video stream from the video camera 605 is integrated into the optimized video stream. Also, in this embodiment, the video cameras are preferably configured to provide close-up views of the rider to get detailed view of the jumps. The video cameras can be set up for the close-up views by adjusting their zoom factor through the PTZ mechanisms. As mentioned earlier, the Time Duration Rule is always in effect in various embodiments. However, in embodiment such as this where a particular video camera is designated for each zone, the Distance Rule would not apply.

In another embodiment, rather than assigning a camera to each zone in the jumping arena 910, an optimal view can be assigned to each zone. The automated video system 100 will then determine which video camera would provide the optimal view depending on the orientation of the rider 800 in each zone. The system will then select the video stream from that video camera to be integrated into the optimized video stream. In this embodiment, the Distance Rule will be in effect to prevent use of the video camera that is too close to the rider 800.

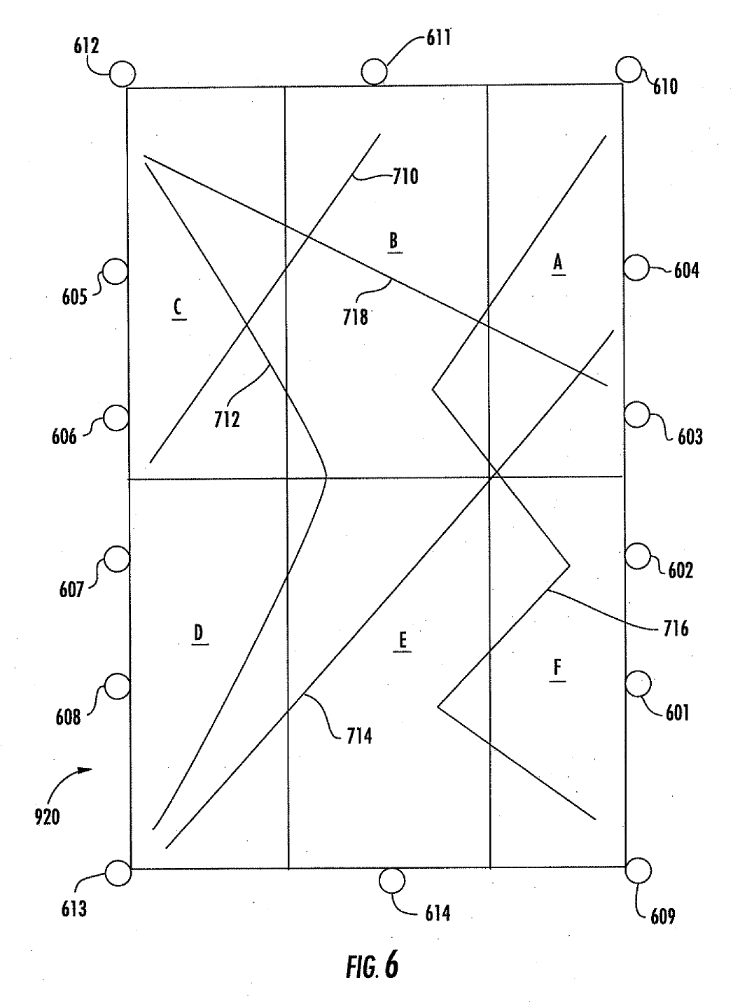

FIG. 6 depicts yet another example of a performance routine for the rider 800 performing dressage training routines the arena 920. FIG. 6 is also a schematic plan view of the practice arena 920. Some examples of various maneuvers involved in dressage are represented by the line segments 710, 712, 714, 716 and 718. Because of the different type of riding involved in dressage versus jumping discussed in reference to FIG. 5, different camera configuration may be required compared to the configuration used for the jumping session. For the dressage training routines, the video cameras are preferably configured for more panoramic view compared to the camera set up used for the jumping training algorithm to provide the maximum coverage of each of the maneuver segments. In turn, the zones associated with the selected video cameras are generally larger than the zones defined for the jumping routines. This can be seen in FIG. 6. The cameras 610, 611, 612, 613, 614 and 609 are assigned to monitor the zones AA, BB, CC, DD, EE and FF. As with the example of FIG. 5, as the rider 800 takes the horse through the various dressage maneuvers, the Target Sensing subsystem 110 keeps track of the position of the rider and generates the target data 112 containing the target's location and orientation information. Using the target data, the Central Command Component 190 determines in which zone the target is and selects the video stream from the video camera assigned to that zone to be integrated into the optimized video stream.

In an embodiment where there are more than one target, the user can assign a subset of video cameras available to the system to a particular target. The targets are then provided with transmitters that transmit unique signals enabling the Target Sensing subsystem 110 to identify and discriminate the position of each target individually. Then, the target data containing the coordinate information of each of the targets is provided to the Central Command Component 190, which in turn utilizes that data to drive the Camera Control subsystem 120 to control the video cameras to track and follow the assigned target. Because each target has its own set of video cameras tracking it and the Target Sensing subsystem 110 is able to determine the position and coordinate of each target independently, the various methods of generating optimal video stream for a single target scenarios described herein are applicable to this multiple target embodiments. Each target is independently tracked and an optimized video stream is generated for each target separately. In this embodiment, more than one video monitors may be provided if necessary to display the play back of each optimized video stream in separate video displays.

Athletes know that there is no better way to improve than to have a trained eye, more knowledgeable than oneself, observe and critique one who is participating. Without some external commentary on the relevant characteristics of an athletic performance, such as form, position, and rhythm, those skilled in the sports understand that there is a limit on how far one can improve. Short of having a skilled trainer with you, the next best thing for maximizing the value of one's practice sessions is to have a detailed video recording of the session, which can be examined and analyzed to improve one's performance. The automated video system 100 intelligently integrates the video streams from the video cameras positioned for the desired optimal views of the target athlete into an optimized video stream that is ideal for such usage.

Furthermore, interrupting the practice session to modify the video camera settings to capture the optimal views is not acceptable, because such interruptions break the flow and rhythm of the athlete. And in the case of equestrian sports, such interruptions would destroy the synergy between the rider and the horse developed during the training session. The synergy between the horse and the rider is of an animalistic nature which cannot be put on “hold.” For these reasons, being able to review the training session while in the arena and on the horse, who is now attentive and responsive from warm up, provides a great deal of value to the practice session. In this way, emotional or attitudinal issues with the horse can be addressed while in the heat of the moment, which makes a more effective in animal training.

While the invention has been particularly shown and described with references to selected embodiments thereof; it will be readily understood by one of ordinary skill in the art that various changes in form and details may be made therein without departing from the scope of the present invention. The present invention is limited only by the appended claims.

We claim:

1. A method for generating an optimized video stream of a target that is moving within a predefined area using an automated video system provided with a plurality of video cameras, each video camera producing a video stream, that are positioned about the predefined area, the method comprising:
defining the predefined area into a plurality of zones;
defining a desired optimal view for each of the zones through which the target will be traveling during a performance routine;
determining the location and orientation of the target as the target is performing the performance routine;
identifying the zone in which the target is as an active zone;
determining a video camera among the plurality of video cameras that has the optimal view of the target defined for the active zone; and
designating the video stream from the selected video camera as the optimized video stream.

2. The method of claim 1, wherein once designated as the optimized video stream, the selected video camera's video stream remains as the optimized video stream for a minimum duration.

3. The method of claim 1, wherein the optimal view for each of the zones has a reference angle of interception associated with the optimal view and the step of determining a video camera that has the optimal view of the target for the active zone comprises:
determining for each of the video cameras, the angle of interception between the video camera's line of sight and the target's orientation axis;
selecting the video camera whose angle of interception is closest to the reference angle of interception associated with the optimal view defined for the active zone.

4. The method of claim 1 further comprising displaying the optimized video stream on to a video display visible to the target.

5. The method of claim 1 further comprising analyzing the video stream from one of the video cameras to detect any abnormalities in the condition of the target or measure performance parameters of the target.

6. The method of claim 1 further comprising transmitting the optimized video stream over a communications network to a remote location.

7. The method of claim I further comprising:
storing the optimized video stream and the video streams from each of the plurality of video cameras;
subsequently recalling the recorded optimized video stream and revising the optimized video stream using the stored video streams from the plurality of video cameras.

8. The method of claim 1, wherein at least one particular zone is assigned to a system command and further comprising the step of:
determining whether the target is in the particular zone;
determining how long the target is staying in the particular zone, wherein if the target stays longer than a predefined length of time in the particular zone the automated video system executes the system command assigned to the particular zone.

9. The method of claim 1, wherein the location of the target is provide as a reference Cartesian space coordinate and further comprising the step of transforming the reference Cartesian space coordinate of the target to a coordinate in Cartesian space of each of the video cameras, thus, allowing the video cameras to track and follow the target.

10. A method for generating an optimized video stream of a target that is moving within a predefined area using an automated video system provided with a plurality of video cameras, each video camera producing a video stream, that are positioned about the predefined area, the method comprising:
defining a desired optimal view for generating the optimized video stream for a performance routine to be performed by the target;
determining the location and orientation of the target as the target is moving through the performance routine;
determining a video camera among the plurality of video cameras that has the optimal view of the target; and
designating the video stream from the video camera having the optimal view as the optimized video stream.

11. The method of claim 10, wherein once designated as the optimized video stream, the selected video camera's video stream remains as the optimized video stream for a minimum duration.

12. The method of claim 10, wherein the optimal view has a reference angle of interception associated with the optimal view and the step of selecting a video camera that has the optimal view of the target comprises:
determining for each of the video cameras, the angle of interception between the video camera's line of sight and the target's orientation axis;
selecting the video camera whose angle of interception is closest to the reference angle of interception associated with the optimal view.

13. The method of claim 10 further comprising displaying the optimized video stream on to a video display visible to the target.

14. The method of claim 10 further comprising analyzing the video stream from one of the video cameras to detect any abnormalities in the condition of the target or measure performance parameters of the target.

15. The method of claim 10 further comprising transmitting the optimized video stream over a communications net work to a remote location.

16. The method of claim 10, wherein at least one particular zone is assigned to a system command and further comprising the step of:
determining whether the target is in the particular zone;
determining how long the target is staying in the particular zone, wherein if the target stays longer than a predefined length of time in the particular zone the automated video system executes the system command assigned to the particular zone.

17. The method of claim 10 further comprising:
storing the optimized video stream and the video streams from each of the plurality of video cameras;
subsequently recalling the recorded optimized video stream and revising the optimized video stream using the stored video streams from the plurality of video cameras.

18. A method for generating an optimized video stream of a target that is moving within a predefined area using an automated video system provided with a plurality of video cameras, each video camera producing a video stream, that are positioned about the predefined area, the method comprising:
defining the predefined area into a plurality of zones;
assigning a video camera from the plurality of video cameras to each of the plurality of zones to provide an optimal view of the target;
tracking the position of the target moving through the predefined area;
identifying the zone in which the target is as an active zone; and
designating the video stream from the video camera assigned to the active zone as the optimized video stream.

19. The method of claim 17 further comprising displaying the optimized video stream on to a video display visible to the target.

20. The method of claim 17 further comprising analyzing the video stream from one of the video cameras to detect any abnormalities in the condition of the target or measure performance parameters of the target.

21. The method of claim 17 further comprising transmitting the optimized video stream over a communications net work to a remote location.

22. The method of claim 17, wherein at least one particular zone is assigned to a system command and further comprising the step of:
determining whether the target is in the particular zone;
determining how long the target is staying in the particular zone, wherein if the target stays longer than a predefined length of time in the particular zone the automated video system executes the system command assigned to the particular zone.

23. An automated video system for generating an optimized video stream of a target that is moving within a predefined area comprising:
a target sensing subsystem for acquiring the location and orientation of the target and generate target location and orientation data;
a plurality of video cameras positioned about the predefined area, each video camera producing a video stream;
a camera control subsystem controlling the video cameras to track the target utilizing the target location data;
a user interface subsystem through which a user defines at least one optimal view of the target to be used for generating the optimized video stream;
a central command component for determining and selecting a video camera among the plurality of video cameras that has the optimal view of the target and designating the video stream from the selected video camera as the optimized video stream, the central command component also controlling and coordinating the functions of the various subsystems;
at least one data storage subsystem for recording the optimized video stream on a storage medium for future play-back; and
at least one display subsystem provided for visually displaying the optimized video stream.

24. The automated video system of claim 23, wherein the target sensing subsystem comprises:
at least one signal transmitter provided on the target for transmitting a unique signal identifying the target; and
a plurality of receivers positioned about the predefined area for receiving the unique signal.

25. The automated video system of claim 23 further comprising an image analysis subsystem for analyzing the video stream from one of the video cameras to detect any abnormalities in the condition of the target or measure performance parameters of the target.
